(19) United States
(12) Patent Application Publication
(10) Pub. No.: US 2011/0174935 A1
(43) Pub. Date: Jul. 21, 2011

(54) SWIVEL-COUPLING HANGER ASSEMBLY

(76) Inventors: Chalice Bingham, Clinton, TN (US); Paul Stevens, Greenback, TN (US)

(21) Appl. No.: 12/691,543

(22) Filed: Jan. 21, 2010

(51) Int. Cl. F16L 3/01; B23P 11/00

(52) U.S. Cl. 248/58; 29/428

(57) ABSTRACT

A swivel-coupling hanger assembly includes an coupling element configured to rotate about a defined geometric axis, coupled to an insulating member. The insulating member may include one or more openings receiving at least a portion of the coupling element. The assembly may further include one or more mechanical fasteners received by an opening of the insulating member such that the assembly may be coupled to a structural member. The assembly may further include a mounting bracket to facilitate attachment to the structural member.

### BACKGROUND OF THE INVENTION

1. Field of the Invention

The present invention generally relates to hanger assemblies. In particular, embodiments relate to swivel-coupling hanger assemblies.

2. Description of the Relevant Art

Hanger assemblies are often used to support and suspend piping systems. More specifically, hanger assemblies may be used to support piping systems subject to substantial thermal expansion and/or contraction. For example, a hanger assembly may be used to mount an exhaust system to the undercarriage or frame of an automobile.

Certain hanger assemblies for securing a portion of an exhaust system to the undercarriage of an automobile include an arm received by the opening of a rubber bushing or insulator surrounded by a metal mounting frame or retaining member. The metal frame, however, tends to restrict movement and inhibit the flexibility of the exhaust system. This restriction of movement can cause premature failure of the hanger assembly and also transfer unwanted noise and vibration into the passenger compartment of the vehicle. Generally the failures occur at weld points, the hanger mounting frame or the hanger mounting rod. Fractures and breakage will usually occur at these contact/connection points on the exhaust system. Also, the metal mounting frames used in these hanger assemblies can open up under stress and loosen, releasing the exhaust system mounting point.

### SUMMARY

Described herein are various embodiments of a swivel-coupling hanger assembly. In an embodiment, the swivel-coupling hanger assembly includes a coupling element and a member composed of an insulating material. The coupling element is disposed in an opening of the member and is rotatable with respect to the member about at least one axis

In certain embodiments, the member includes a mounting portion and a coupling portion in which the opening is disposed. In some embodiments, the mounting portion comprises an opening which, during use, receives a fastener to be positioned in the opening to couple the member to a surface. In certain embodiments, a bushing is disposed in a portion of the opening of the mounting portion of the member.

In some embodiments, the swivel-coupling hanger includes a mounting bracket coupled to the member such that, during use, the mounting bracket may be coupled to an external component.

The swivel-coupling assembly may be used to couple parts to an automobile surface. For example, the swivel-coupling assembly may couple an exhaust system to a bottom surface of an automobile.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1 is a perspective view of an embodiment of a swivel-coupling hanger;

FIG. 2 is a detailed view of an coupling element;

FIG. 3 is a detailed view of an insulating member;

FIGS. 4A-4D are side views of the coupling element of a swivel-coupling hanger progressively rotating; and

FIG. 5 is a perspective view of a swivel-coupling hanger coupled to an automobile exhaust system.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

In the context of this application, the following terms are defined as:

A “mechanical fastener” refers to a fastener that is used to couple two or more parts together by force. Examples of a mechanical fastener include, but are not limited to, a bolt or a screw.

An “insulating material” refers to any material composition capable of preventing or reducing the passage, transfer, or leakage, of one or more of heat, electricity, sound, or vibrations. Examples of an insulating material include, but are not limited to, natural and synthetic rubbers.

“Rubber” refers to any elastic polymeric materials. The term “rubber” includes synthetic and natural rubbers. Examples of synthetic rubbers include, but are not limited to: poly (bromo isobutylene isoprene); polybutadiene; poly (chloro isobutylene isoprene); polychloroprene; poly (chlorosulphonated polyethylene); poly (epichlorohydrin); poly (ethylene propylene); poly (ethylene propylene diene monomer); poly (fluoronated hydrocarbon); poly (fluoro silicone); poly (hydrogenated nitrile butadiene); polyisoprene; poly (isobutylene isoprene butyl); poly (methyl vinyl silicone); poly (acrylonitrile butadiene); polyurethane; poly (styrene butadiene); poly (styrene ethylene/butylene styrene); polysiloxane; and poly (acrylonitrile butadiene carboxy monomer)

A “bracket” refers to any member, or combination of members, capable of supporting, or partially supporting, an additional component of the assembly.

An “opening axis” refers to the line formed through the center of an opening.

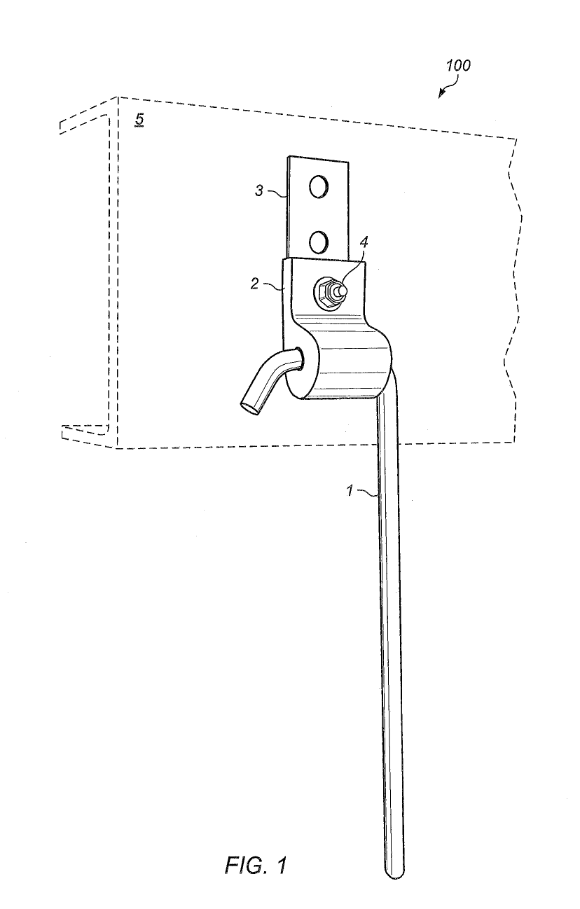

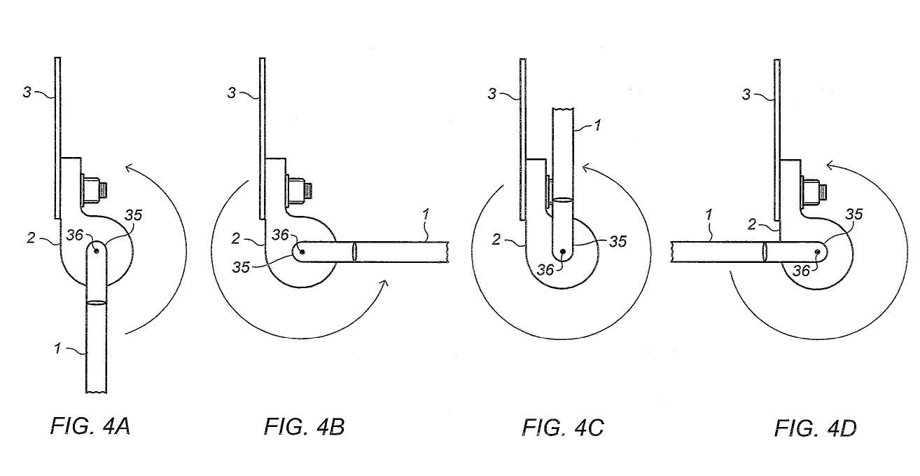

FIG. 1 illustrates an embodiment of a swivel-coupling hanger. Suitable locations for mounting a swivel-coupling hanger include, for example, the understructure or frame of an automobile and the walls or ceiling of a defined enclosure. Swivel-coupling hanger 100 includes coupling element 1 coupled to member 2. Member 2 may be coupled to mounting bracket 3 via fastener 4. Mounting bracket 3 may at least partially support member 2. Mounting bracket 3 is mounted to structural element 5 via fastener 4 (for clarity, only a portion of structural element 5 is shown in FIG. 1). In some embodiments, coupling element 1 rotates about a defined geometric axis while member 2 and mounting bracket 3 remain fixed (see for example FIGS. 4A-4C).

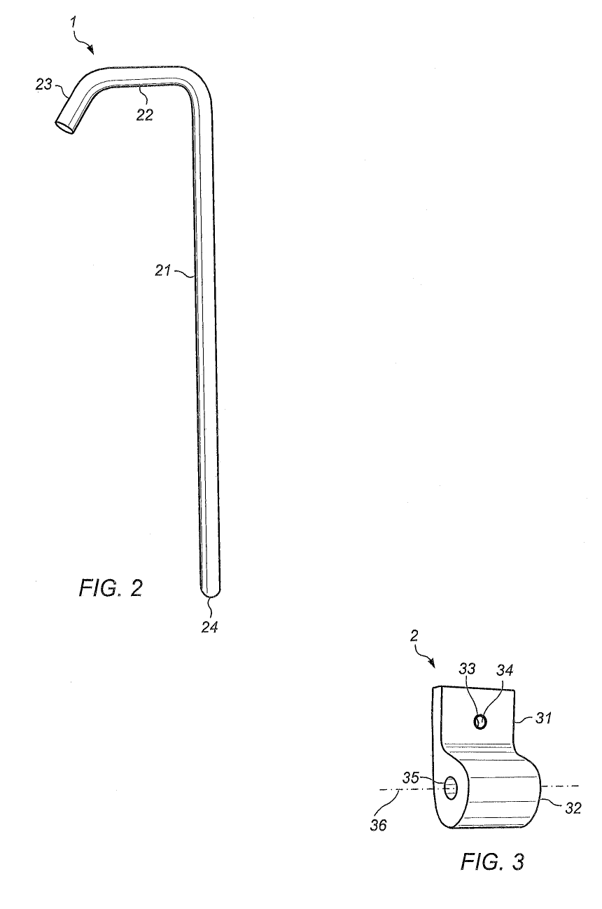

FIG. 2 depicts the coupling element 1 of the embodiment shown in FIG. 1. Coupling element 1 includes substantially vertical portion 21, substantially horizontal portion 22, and oblique portion 23. Portions of coupling element 1 may be of any predetermined length. Further, portions of coupling element 1 may be of any suitable cross-section, material, or thickness. In some embodiments, coupling element 1 is configured such that when coupled to member 2 the coupling element is substantially locked axially. That is, coupling element 1 is held in place axially by member 2 such that dislodgement of the coupling element is inhibited. For example, according to the embodiment depicted in FIG. 1, the opening of member 2 receiving horizontal portion 22 of the coupling element may inhibit axial displacement of the coupling element in all directions tangent to a portion of the wall of the opening, while the bends (25 and 26) of coupling element 1, distinguishing the vertical portion 21 and oblique portion 23 from horizontal portion 22, may inhibit axial displacement in the horizontal direction.

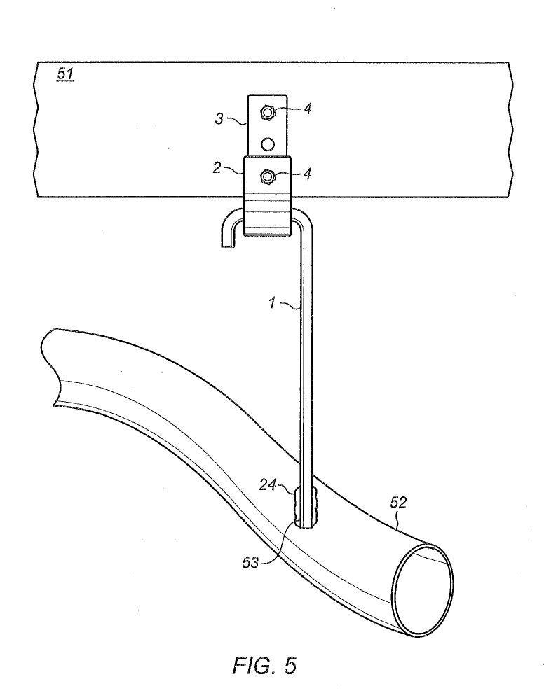

Returning again to FIG. 2, in some embodiments, one or more portions of coupling element 1 are weldable to one or more structural elements (see for example FIG. 5). In certain embodiments, distal end 24 of coupling element 1 may include a hook, or any other means of attachment to an additional element. For example, distal end 24 of coupling element 1 may be welded or hooked to a conduit or pipe. According to the embodiment, all portions of coupling element 1 are integrally formed. In certain embodiments, however, a coupling element may include one or more mechanically or chemically attached portions.

FIG. 3 depicts the member 2 of the embodiment shown in FIG. 1. According to the embodiment, member 2 includes mounting portion 31 integrally formed with coupling portion 32. Mounting portion 31 may be of any predetermined thickness, size, or cross-section. Mounting portion 31 includes an opening 33. Opening 33 may be of any shape or cross-section. In some embodiments, opening 33 is threaded in accordance with a predetermined thread pattern. In some embodiments, a bushing 34 is press fit along the interior of opening 33. According to an embodiment, bushing 34 is composed of a metal that is capable of preventing excessive wear due to stress concentrations proximate opening 33. A bushing, however, may be produced of any suitable material. According to an embodiment, opening 33 extends entirely through mounting portion 31. In certain embodiments, however, opening 31 may extend to any predetermined depth. Coupling portion 32 includes opening 35. Opening 35 defines opening axis 36. According to an embodiment, opening axis 36 is substantially perpendicular with respect to the longitudinal axis of member 2. An opening axis, however, may also be oblique or substantially parallel to the longitudinal axis.

In some embodiments, member 2 is produced of an insulating material. For example, member 2 may be produced of a high strength rubber. In certain embodiments, member 2 is substantially compatible with automobile fluids, salts, aqueous acidic compositions, and aqueous basic compositions. That is, member 2 does not adversely react with automobile fluids, salts, aqueous acidic compositions, and aqueous basic compositions. In certain embodiments, member 2 is also substantially tolerant to heat and/or ozone. For example, member 2 may be able to withstand or endure the high heat and/or ozone conditions produced by an automobile exhaust system.

FIGS. 4A-4D illustrate the rotating action of a swivel-coupling hanger 100. Coupling element 1 rotates, while retained axially by opening 35 of member 2, about opening axis 36. In some embodiments, coupling element 1 is capable of rotating a full 360° about opening axis 36. During use, the rotation of coupling element 1 may be restricted by surrounding components or the structural element to which member 2 is coupled. In certain embodiments, coupling element 1 is received by opening 35 of member 2 such the rotation of coupling element 1 is free of any predetermined resistive forces. In other embodiments, member 2 imparts a predetermined resistive force on coupling element 1 which must be overcome to initiate rotation.

FIG. 5 depicts an application of swivel-coupling hanger 100 coupled to an automobile exhaust system. Mounting bracket 3 is coupled to automobile frame 51 via fasteners 4a and 4b. Member 2 is coupled to mounting bracket 3 and automobile frame 51 via fastener 4b. Distal end 24 of coupling element 1 is welded (see weld joint 53) to exhaust pipe 52 of an automobile exhaust system. The configuration of member 2, being free of any rigid encasement, may allow substantially unrestricted circumferential movement of the automobile exhaust system while providing axial stability. The swivel-coupling hanger provides ample flexibility and support, thus avoiding premature failure and transfer of unwanted noise and vibration into the passenger compartment of the automobile. Further, by providing flexibility, the swivel-coupling hanger is able to accommodate the changes in length, height, and/or thickness associated with the co-efficient of thermal expansion of exhaust system components while the engine is running and also contraction of said components such as occurs during the cooling cycle when the engine of the vehicle is turned off. Thus, the stresses imparted on the exhaust system by both thermal expansion and contraction are relieved. The swivel-coupling hanger will also reduce stress on the exhaust system during movement of the vehicle by allowing the system to be more flexible during vehicle jounce due to normal suspension oscillations.

In some embodiments, an automobile exhaust system may be suspended by a plurality of swivel-coupling hangers.

An automobile exhaust system may be mounted to an automobile using one or more swivel-coupling hangers. In an embodiment, one or more swivel-coupling assemblies are coupled to the automobile. Components of the exhaust system may be coupled to, or attached directly to one or more of the swivel-coupling assemblies. In one embodiment, one or more components of the automobile exhaust system are welded to the coupling member. Mounting brackets may be used to mount the swivel-coupling assemblies to the automobile. In one embodiment, one or more swivel-coupling assemblies are coupled to the automobile. One or more of the swivel-coupling assemblies are coupled to the mounting brackets, thus coupling the one or more swivel-coupling assemblies to the automobile. In an alternate embodiment, one or more swivel-coupling assemblies may be coupled to the mounting bracket, prior to coupling the mounting bracket to the automobile.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A swivel-coupling assembly comprising:
a coupling element; and
a member composed of an insulating material, wherein the member comprises a coupling portion and a mounting portion, wherein the coupling element is disposed in an opening of the coupling portion of the member; and wherein the member is mounted to a surface via the mounting portion during use; and
wherein the coupling element is rotatable with respect to the member about at least one axis.

2. The swivel-coupling assembly of claim 1, wherein insulating material is rubber.

3. The swivel-coupling assembly of claim 1, wherein the mounting portion of the member comprises an opening which, during use, receives a fastener to be positioned in the opening to couple the member to a surface.

4. The swivel-coupling assembly of claim 3, wherein a bushing is disposed in the opening of the mounting portion of the member.

5. The swivel-coupling assembly of claim 4, wherein the bushing is a metallic, press-fit bushing.

6. The swivel-coupling assembly of claim 1, wherein the coupling element is composed of a material that can be welded to a surface.

7. The swivel-coupling assembly of claim 1, wherein the coupling portion and the mounting portion of the member define a longitudinal axis, and wherein the axis of the opening is substantially perpendicular with respect to the longitudinal axis of the member.

8. The swivel-coupling assembly of claim 1, wherein the coupling element comprises a first portion, a second portion, and a third portion, wherein the second portion is disposed in the opening, the first portion extends at an angle from the second portion, and the third portion extends at an angle from the second portion, the third portion coupling the member to an external component.

9. The swivel-coupling assembly of claim 1, further comprising a mounting bracket coupled to the mounting portion of the member, wherein the mounting bracket, during use, couples the mounting portion of the member to a surface.

10. The swivel-coupling assembly of claim 1, wherein the coupling portion of the member is substantially cylindrical, and wherein the mounting portion is substantially planar.

11. An automobile exhaust system comprising:
at least one exhaust pipe; and
one or more swivel-coupling assemblies comprising:
a coupling element; and
a member composed of an insulating material, wherein the member comprises a coupling portion and a mounting portion, wherein the coupling element is disposed in an opening of the coupling portion of the member; and wherein the member is mounted to a surface via the mounting portion during use; and
wherein the coupling element is rotatable with respect to the member about at least one axis; and
wherein the at least one exhaust pipe is at least partially coupled to the automobile by the one or more swivel-coupling assemblies.

12. The automobile exhaust system of claim 11, wherein insulating material is rubber.

13. The automobile exhaust system of claim 11, wherein the mounting portion of the member comprises an opening which, during use, receives a fastener to be positioned in the opening to couple the member to a surface.

14. The automobile exhaust system of claim 13, wherein a bushing is disposed in the opening of the mounting portion of the member.

15. The automobile exhaust system of claim 14, wherein the bushing is a metallic, press-fit bushing.

16. The automobile exhaust system of claim 11, wherein the coupling element is composed of a material that can be welded to a surface.

17. The automobile exhaust system of claim 11, wherein the coupling portion and the mounting portion of the member define a longitudinal axis, and wherein the axis of the opening is substantially perpendicular with respect to the longitudinal axis of the member.

18. The automobile exhaust system of claim 11, wherein the coupling element comprises a first portion, a second portion, and a third portion, wherein the second portion is disposed in the opening, the first portion extends at an angle from the second portion, and the third portion extends at an angle from the second portion, the third portion coupling the member to an external component.

19. The automobile exhaust system of claim 11, further comprising a mounting bracket coupled to the mounting portion of the member, wherein the mounting bracket, during use, couples the mounting portion of the member to a surface.

20. The automobile exhaust system of claim 11, wherein the coupling portion of the member is substantially cylindrical, and wherein the mounting portion is substantially planar.

21. A method of installing an exhaust system on an automobile comprising:
coupling one or more swivel-coupling assemblies to the automobile, one or more of the swivel-coupling assemblies comprising:
a coupling element; and
a member composed of an insulating material, wherein the member comprises a coupling portion and a mounting portion, wherein the coupling element is disposed in an opening of the coupling portion of the member;
wherein the coupling element is rotatable with respect to the member about at least one axis; and
wherein the one or more swivel assemblies is coupled to the automobile via the mounting portion; and
coupling the exhaust system to the automobile using the coupling element of one or more of the swivel-coupling assemblies.

22. The method of claim 21, wherein insulating material is rubber.

23. The method of claim 21, wherein the mounting portion of the member comprises an opening, the method further comprising coupling the swivel-coupling assembly to the automobile with a fastener positioned in the opening.

24. The method of claim 23, wherein a bushing is disposed in the opening of the mounting portion of the member.

25. The method of claim 24, wherein the bushing is a metallic, press-fit bushing.

26. The method of claim 21, wherein coupling the exhaust system to the automobile comprises welding a portion of the exhaust system to one or more coupling elements of one or more of the swivel-coupling assemblies.

27. The method of claim 21, wherein the coupling portion and the mounting portion of the member define a longitudinal axis, and wherein the axis of the opening is substantially perpendicular with respect to the longitudinal axis of the member.

28. The method of claim 21, wherein the coupling element comprises a first portion, a second portion, and a third portion, wherein the second portion is disposed in the opening, the first portion extends at an angle from the second portion, and the third portion extends at an angle from the second portion, the third portion coupling the member to an external component.

29. The method of claim 21, further comprising coupling one or more mounting brackets to a portion of the automobile, and wherein coupling one or more swivel-coupling assemblies to the automobile comprises coupling one or more members or one or more of the swivel-coupling assemblies to one or more mounting brackets coupled to the automobile.

30. The method of claim 21, wherein the coupling portion of the member is substantially cylindrical, and wherein the mounting portion is substantially planar.
